(19) United States
(12) Patent Application Publication
(10) Pub. No.: US 2024/0138524 A1
(43) Pub. Date: May 2, 2024

(54) METHOD FOR ATTACHING ADHESIVE TO SHOE SOLE

(71) Applicants: Chi-Chien LAI, New Taipei City (TW); PUMMA TECHNOLOGY CO., LTD., Taichung City (TW)

(72) Inventor: Hsin-Ming TSENG, Taichung City (TW)

(21) Appl. No.: 18/155,661

(22) Filed: Jan. 17, 2023

(30) Foreign Application Priority Data
Oct. 31, 2022 (TW) 111141416

(51) Int. Cl. A43D 25/18; A43D 25/06; B05D 3/02

(52) U.S. Cl. CPC A43D 25/185; A43D 25/06; B05D 3/0218

(57) ABSTRACT

A method for attaching an adhesive to a shoe sole which has a top surface includes the steps of: (A) capturing a shape of the top surface of the shoe sole and generating a preset pattern using a sampling device, the preset pattern having a contour corresponding to the shape of the top surface and an area similar to that of the top surface; (B) preparing a mold according to the preset pattern; (C) coating the adhesive on the mold and allowing the adhesive to stand for a while; (D) cooling the mold to a degumming temperature; (E) pressing the mold against the shoe sole with a surface thereof having the adhesive facing the top surface so as to attach the adhesive thereto; and (F) moving the mold away from the shoe sole to separate the mold from the adhesive.

### CROSS-REFERENCE TO RELATED APPLICATION

This application claims priority to Taiwanese Invention Patent Application No. 111141416, filed on Oct. 31, 2022.

### FIELD

The disclosure relates to a shoemaking process, and more particularly to a method for attaching an adhesive to a shoe sole.

### BACKGROUND

Generally, when a shoe upper is adhered to a shoe sole, it is necessary to first draw a line on the shoe upper according to the contour of the periphery of the shoe sole so as to serve as a reference line for coating an adhesive. Since the shoe sole has a multi-curved three-dimensional shape, requirements on the uniformity of adhesive coating thickness is high. Currently, most of the industry uses skilled technicians to take care of this operation process.

However, when the adhesive is coated, it is still inevitable that the adhesive will overflow out of the reference line and cause excessive amount of adhesive which can affect an appearance, or will be less than the reference line and cause insufficient amount of the adhesive which will have the problem of causing separation of the shoe sole from the shoe upper or insufficient tensile strength. Furthermore, the adhesive generally contains a high fluidity solvent for easy application, so a shoe material still need to go through a drying process after being coated with the adhesive to volatilize the solvent components in the adhesive and ensure its effectiveness. The drying process generally uses a conveyor belt that passes through multiple drying devices for baking the shoe material at a certain temperature for a long time so as to ensure evaporation of the solvent. The drying devices not only consume a lot of energy, but also occupy a large area, and must be equipped with corresponding manpower. The adhering process of the shoe material is a key process that determines the quality of shoemaking in the shoemaking production line. Therefore, the problems of poor product quality and high energy consumption derived from the aforementioned unstable coating of the adhesive still need to be further overcome.

### SUMMARY

Therefore, an object of the present disclosure is to provide a method for attaching an adhesive to a shoe sole that can alleviate at least one of the drawbacks of the prior art.

Accordingly, the method of this disclosure is suitable for attaching an adhesive to a shoe sole which has a top surface. The method of this disclosure includes the steps of: (A) capturing a shape of the top surface of the shoe sole and generating a preset pattern using a sampling device, the preset pattern having a contour corresponding to the shape of the top surface of the shoe sole and an area similar to that of the top surface of the shoe sole; (B) preparing a mold according to the preset pattern; (C) coating the adhesive on the mold and allowing the adhesive to stand for a while; (D) cooling the mold to a degumming temperature; (E) pressing the mold against the shoe sole with a surface thereof having the adhesive facing the top surface of the shoe sole so as to attach the adhesive to the top surface of the shoe sole; and (F) moving the mold away from the shoe sole to separate the mold from the adhesive.

### BRIEF DESCRIPTION OF THE DRAWINGS

Other features and advantages of the disclosure will become apparent in the following detailed description of the embodiment with reference to the accompanying drawings. It is noted that various features may not be drawn to scale.

FIG. 1 is a flow chart, illustrating the steps involved in a method for attaching an adhesive to a shoe sole according to an embodiment of the present disclosure;

FIG. 2 is a perspective schematic diagram of the embodiment illustrating the process of generating a preset pattern.

FIG. 3 is a perspective view illustrating an adhesive coated on a transfer portion of a mold.

FIG. 4 is a front view illustrating the adhesive on the transfer portion of the mold facing a shoe sole.

FIG. 5 is a sectional view illustrating the mold and the adhesive pressing against a top surface of the shoe sole.

FIG. 6 is a perspective view illustrating the adhesive attached to the top surface of the shoe sole.

### DETAILED DESCRIPTION

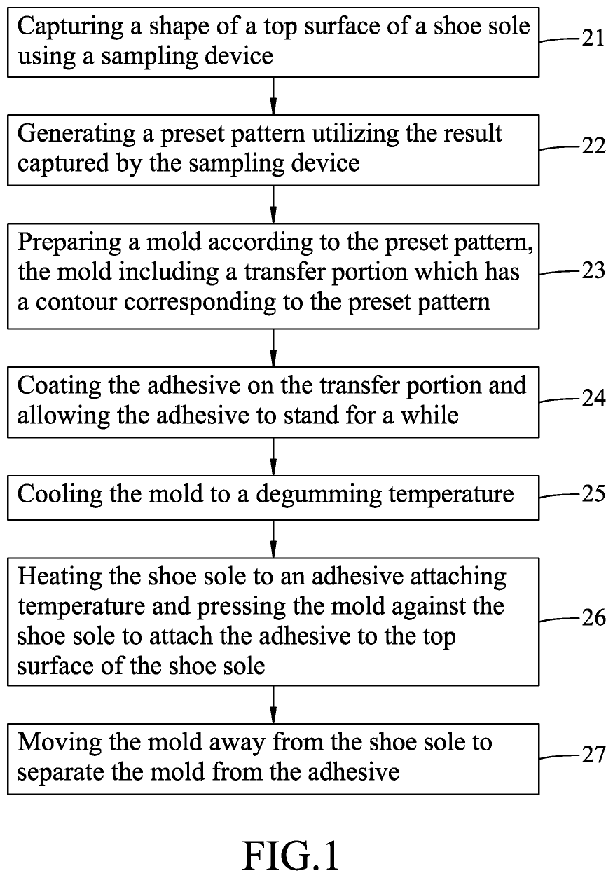

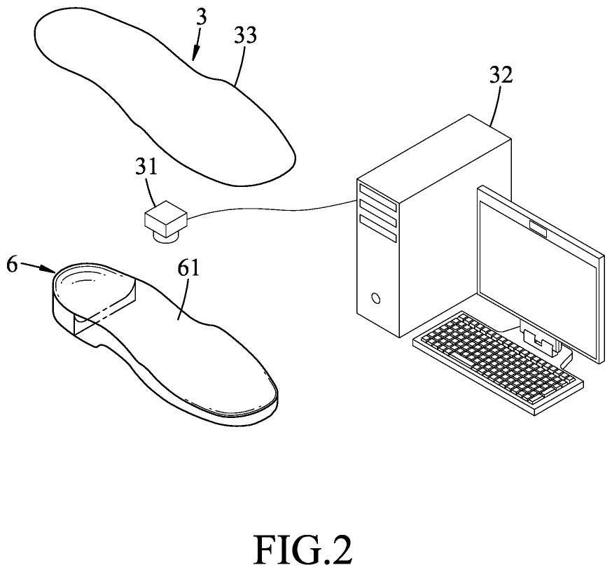

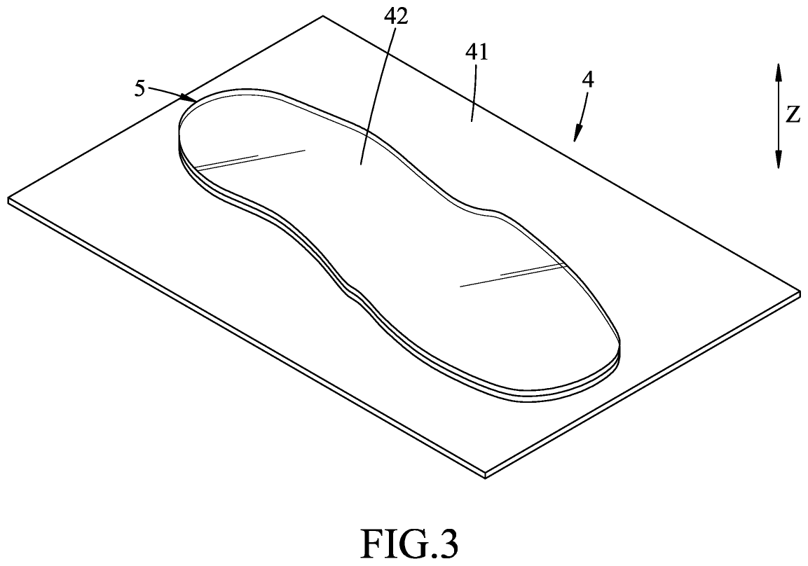

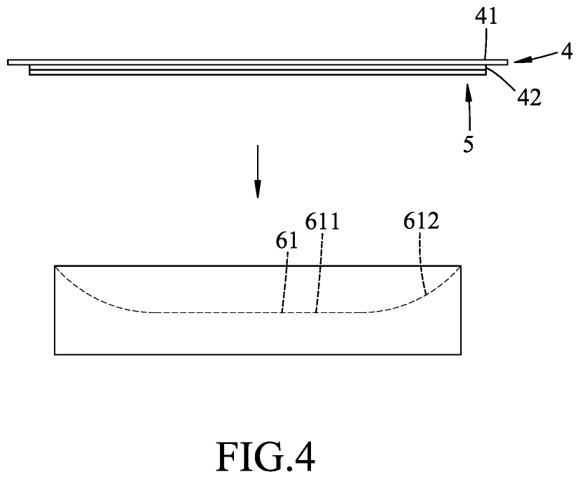

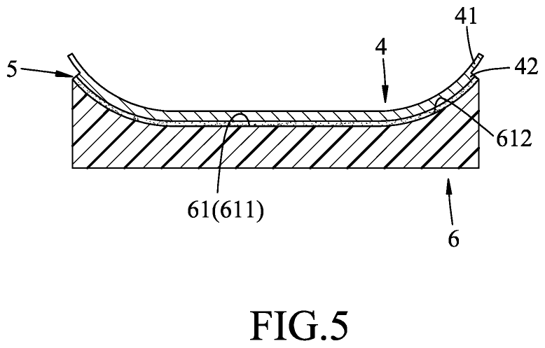

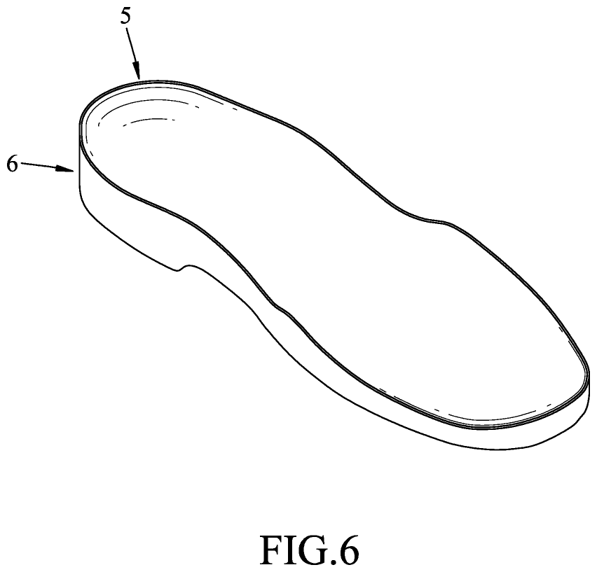

Referring to FIGS. 1 to 6, a method according to an embodiment of the present disclosure is suitable for attaching an adhesive 5 to a shoe sole 6. The shoe sole 6 has a top surface 61. The top surface 61 has a sole region 611 corresponding to the foot sole of a person, and a side wall region 612 extending outwardly and upwardly from an outer periphery of the sole region 611. The method of this disclosure comprises steps 21 to 27.

In step 21, a shape of the top surface 61 of the shoe sole 6 is captured using a sampling device 3. The sampling device 3 includes an image capture unit 31, and a pattern generation unit 32 signally connected to the image capture unit 31. In this embodiment, the image capture unit 31 is a camera lens, while the pattern generation unit 32 includes a computer and a graphic software installed in the computer, but not limited thereto.

In step 22, a preset pattern 33 is generated utilizing the result captured by the sampling device 3. The preset pattern 33 is flat, and has a contour corresponding to the shape of the top surface 61, and an area similar to that of the top surface 61. Specifically, in this embodiment, the sole region 611 and the side wall region 612 are at an angle relative to each other, but not limited thereto. In other embodiments, the sole region 611 and the side wall region 612 may be parallel to each other. The sampling device 3 can capture the shape and calculate the total area of the sole region 611 and the side wall region 612 to generate the flat preset pattern 33. In other embodiments, other equivalent components that can capture and calculate the shape and area of the top surface 61 may be selected according to the requirements.

In step 23, a mold 4 is prepared according to the preset pattern 33. The mold 4 includes a base seat 41, and a transfer portion 42 protruding from a top surface of the base seat 41 along a height direction (Z). The transfer portion 42 has a contour corresponding to the preset pattern 33, and a thickness of 1 to 2 mm along the height direction (Z). In this embodiment, the mold 4 is made of silicone, but not limited thereto. In other embodiments, the mold 4 may be selected from other durable and flexible materials according to the requirements.

In step 24, the adhesive 5 is coated on a surface of the transfer portion 42 that is distal to the base seat 41, and is allowed to stand for a while. In this embodiment, the adhesive 5 is coated on the transfer portion 42 by a roller coater, and is evenly distributed on the transfer portion 42 by itself due to its fluidity. In other embodiments, other methods and tools (such as brushing or spraying) that can stably and evenly applied the adhesive 5 on the transfer portion 42 may be selected, and are not limited to what is disclosed herein. It should be noted that, in this embodiment, the adhesive 5 on the transfer portion 42 has a thickness of 0.3 to 0.5 mm and a weight of less than 5 grams. Further, the adhesive 5 is allowed to stand on the transfer portion 42 for about 10 seconds.

In step 25, with reference to FIGS. 1, 4 and 5, the mold 4 is cooled to a degumming temperature. In this embodiment, the degumming temperature is room temperature, and the mold 4 is placed in a room temperature environment for about 4 to 6 minutes to cool to the degumming temperature, or a fan (not shown) is used to blow the mold 4 for about 2 to 3 minutes to cool to the degumming temperature.

In step 26, the shoe sole 6 is first heated to an adhesive attaching temperature, after which the mold 4 is pressed against the shoe sole 6 with the adhesive 5 facing the top surface 61 of the shoe sole 6 so as to attach the adhesive 5 thereto. It is worth mentioning that, in this embodiment, the adhesive attaching temperature is about 55 to 58° C., preferably 55° C., the pressing time is about 10 to 20 seconds, and the time for heating the shoe sole 6 to the adhesive attaching temperature is about 10 to 15 seconds, but not limited thereto. In other embodiments, the pressing time and the heating time may be adjusted according to the materials of the adhesive 5 and the shoe sole 6.

In step 27, with reference to FIGS. 1, 5 and 6, the mold 4 is moved away from the shoe sole 6 to separate the transfer portion 42 from the adhesive 5.

It should be noted that the adhesive 5 used in this embodiment is polyurethane (PUR) hot melt adhesive, which has high adhesion at 55° C. and low adhesion at room temperature. Therefore, the adhesive 5 can be stably attached to the shoe sole 6 when the shoe sole 6 is heated to 55° C., and can be easily separated from the mold 4 at room temperature.

After going through the aforesaid steps, the adhesive 5 coated on the top surface 61 of the shoe sole 6 may be activated by ultraviolet light, heating or humidification according to the properties of the adhesive 5, so that the adhesive 5 can be used in other processes, such as adhering of a shoe upper, etc.

In comparison with the existing adhesive coating technique, the method of this disclosure can obtain the shape and area of the top surface 61 of the shoe sole 6 using the sampling device 3, so that the shape and area of the surface of the transfer portion 42 of the mold 4 can correspond to the shape and area of the top surface 61. When the mold 4 is pressed against the shoe sole 6, the adhesive 5 is neither too large or too small for the top surface 61, and the contour thereof also corresponds to the shape of the top surface 61, so that the adhesive 5 can be attached to the top surface 61 of the shoe sole 6 in a stable, repeatable and easy-to-operate manner, thereby avoiding the problems of excessive, insufficient, different range or uneven coating of adhesive caused by manual direct coating. Furthermore, there is no need to go through the time consuming, high energy consuming, and manpower consuming drying process to volatilize the solvent components in the adhesive 5, so that the effects of improving the quality of the product and reducing energy consumption can be achieved. Moreover, this disclosure avoids use of volatile solvents (such as toluene) for preventing the workers from inhaling harmful gases and reducing the emission of harmful gases, so that the effects of improving work safety and reducing pollution can be achieved. Therefore, the object of this disclosure can indeed be achieved.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A method for attaching an adhesive to a shoe sole, the shoe sole having a top surface, the method comprising the steps of:
(A) capturing a shape of the top surface of the shoe sole and generating a preset pattern using a sampling device, the preset pattern having a contour corresponding to the shape of the top surface of the shoe sole and an area similar to that of the top surface of the shoe sole;
(B) preparing a mold according to the preset pattern;
(C) coating the adhesive on the mold and allowing the adhesive to stand for a while;
(D) cooling the mold to a degumming temperature;
(E) pressing the mold against the shoe sole with a surface thereof having the adhesive facing the top surface of the shoe sole so as to attach the adhesive to the top surface of the shoe sole; and
(F) moving the mold away from the shoe sole to separate the mold from the adhesive.

2. The method as claimed in claim 1, wherein the sampling device includes an image capture unit, and a pattern generation unit signally connected to the image capture unit.

3. The method as claimed in claim 1, wherein the mold includes a base seat, and a transfer portion protruding from a top surface of the base seat along a height direction, the transfer portion having a contour corresponding to the preset pattern, the adhesive being coated on a surface of the transfer portion that is distal to the base seat.

4. The method as claimed in claim 3, wherein the transfer portion has a thickness of 1 to 2 mm along the height direction.

5. The method as claimed in claim 1, wherein, in step (C), the adhesive is allowed to stand on the mold for about 10 seconds.

6. The method as claimed in claim 1, wherein, in step (D), the mold is cooled to a degumming temperature by placing the mold in a room temperature environment.

7. The method as claimed in claim 1, wherein, in step (D), the mold is cooled to a degumming temperature by using a fan.

8. The method as claimed in claim 1, wherein the degumming temperature is room temperature.

9. The method as claimed in claim 1, wherein, prior to pressing the mold against the shoe sole in step (E), the shoe sole is first heated to an adhesive attaching temperature.

10. The method as claimed in claim 9, wherein the adhesive attaching temperature is about 55 to 58° C.
